(19) United States
(12) Patent Application Publication
(10) Pub. No.: US 2025/0123516 A1
(43) Pub. Date: Apr. 17, 2025

(54) DISPLAY DEVICE

(71) Applicant: Coretronic Corporation, Hsin-Chu (TW)

(72) Inventors: Ping-Yen Chen, Hsin-Chu (TW); Chung-Yang Fang, Hsin-Chu (TW); Yang-Ching Lin, Hsin-Chu (TW)

(73) Assignee: Coretronic Corporation, Hsin-Chu (TW)

(21) Appl. No.: 18/912,473

(22) Filed: Oct. 10, 2024

(30) Foreign Application Priority Data
Oct. 13, 2023 (CN) 202311324926.1

(51) Int. Cl. G02F 1/1335; G02F 1/13363; G02F 1/167; G02F 1/1677

(52) U.S. Cl. CPC G02F 1/133531; G02F 1/133638; G02F 1/167; G02F 1/1677; G02F 2203/02; G02F 2413/13; G02F 2413/14

(57) ABSTRACT

Disclosed is a display device including a front light module, a first polarizing module, and a reflective display unit. A light guide plate is located between the first polarizing module and the reflective display unit. The front light module includes a light guide plate and a light source. The light source is disposed next to a light incident surface of the light guide plate. The first polarizing module includes a first polarizer and a first quarter wave plate, where the first quarter wave plate is located between the light guide plate and the first polarizer. There is a first air gap layer between the light guide plate and the first quarter wave plate. The display device disclosed has good optical efficiency and contrast.

### CROSS-REFERENCE TO RELATED APPLICATION

This application claims the priority benefit of China application serial no. 202311324926.1, filed on Oct. 13, 2023. The entirety of the above-mentioned patent application is hereby incorporated by reference herein and made a part of this specification.

### BACKGROUND

### Technical Field

The disclosure relates to an electronic device, and in particular to a display device.

### Description of Related Art

In the existing technology, electronic paper displays or reflective displays can illuminate a display layer of a display by ambient light to achieve a purpose for display. Therefore, a back light source is no need, and power consumption can be saved. In order to expand the scope of application of using reflective displays without sufficient ambient light, a front light module with a light guide plate and a light source is generally disposed on a front panel of the display. The light emitted by the light source can travel in the light guide plate in a total internal reflection manner, and is transmitted to a direction of the display by a microstructure disposed on a surface of the light guide plate to convert the light source into a surface light source with uniform optical distribution. The light transmitted to the display can then be reflected by the display and transmitted to the viewer. A purpose of setting up the front light module is to allow the above-mentioned display to provide sufficient incident light for the user to watch a displayed image even in a place with insufficient ambient light.

However, a part of the light traveling in the light guide plate may penetrate the light guide plate and be directly transmitted to the user to form stray light without being transmitted to the direction of the display. As a result, the generation of the stray light may cause design problems and energy loss of the light guide plate, and the contrast of the image displayed by the display may also be decreased.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides a display device. The display device includes a front light module, a first polarizing module, and a reflective display unit. The front light module includes a light guide plate and a light source. The light source is disposed next to a light incident surface of the light guide plate. The first polarizing module includes a first polarizer and a first quarter wave plate, where the first quarter wave plate is located between the light guide plate and the first polarizer, and there is a first air gap layer between the light guide plate and the first quarter wave plate. The light guide plate is located between the first polarizing module and the reflective display unit.

Other objectives, features and advantages of the disclosure will be further understood from the further technological features disclosed by the embodiments of the disclosure where there are shown and described preferred embodiments of this disclosure, simply by way of illustration of modes best suited to carry out the disclosure.

### BRIEF DESCRIPTION OF THE DRAWINGS

FIG. 1 is a block diagram of a display device according to an embodiment of the disclosure.

FIG. 2 is a schematic structural diagram of the display device in FIG. 1.

FIG. 3 is a schematic diagram of a light path reflected on different interfaces by an illumination light beam of a light source in the display device in FIG. 2.

FIG. 4A to FIG. 4C are schematic diagrams of light paths reflected on different interfaces by ambient light incident on the display device in FIG. 2.

FIG. 5A is a schematic diagram of another light path reflected on different interfaces by the illumination light beam of the light source in the display device in FIG. 2.

FIG. 5B is a schematic diagram of another light path reflected on different interfaces by the ambient light incident on the display device in FIG. 2.

FIG. 6 is a schematic structural diagram of another display device in FIG. 1.

### DESCRIPTION OF THE EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B”” component or one or more additional components are between “A” component and “B” component. Accordingly, the drawings and descriptions will be regarded as illustrative in nature and not as restrictive.

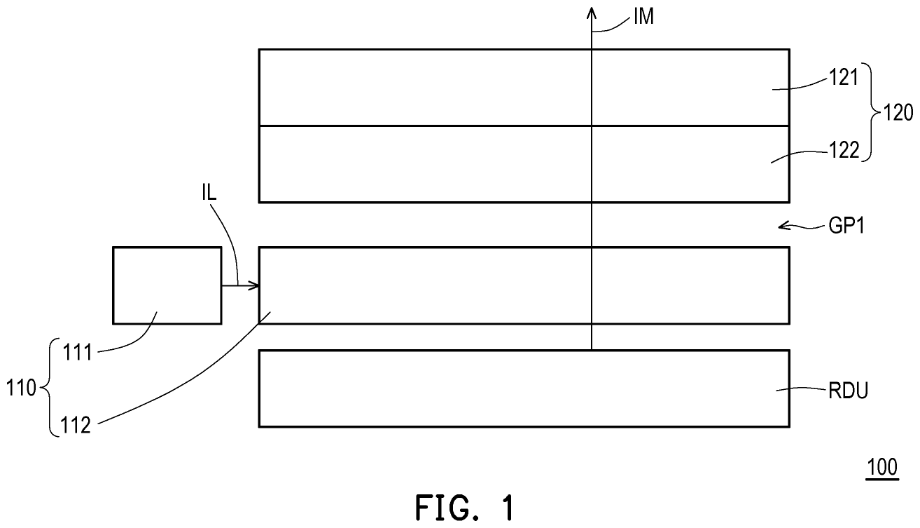

FIG. 1 is a block diagram of a display device according to an embodiment of the disclosure. Referring to FIG. 1, in this embodiment, a display device 100 includes a front light module 110, a first polarizing module 120, and a reflective display unit RDU. Specifically, as shown in FIG. 1, in this embodiment, the front light module 110 includes a light guide plate 112 and a light source 111. The light source 111 is configured to provide an illumination light beam IL, where the light guide plate 112 is located on a transmission path of the illumination light beam IL.

Moreover, as shown in FIG. 1, in this embodiment, the first polarizing module 120 includes a first polarizer 121 and a first quarter wave plate 122, where the first quarter wave plate 122 is located between the light guide plate 112 and the first polarizer 121. The light guide plate 112 is located between the first polarizing module 120 and the reflective display unit RDU, and there is a first air gap layer GP1 between the light guide plate 112 and the first quarter wave plate 122.

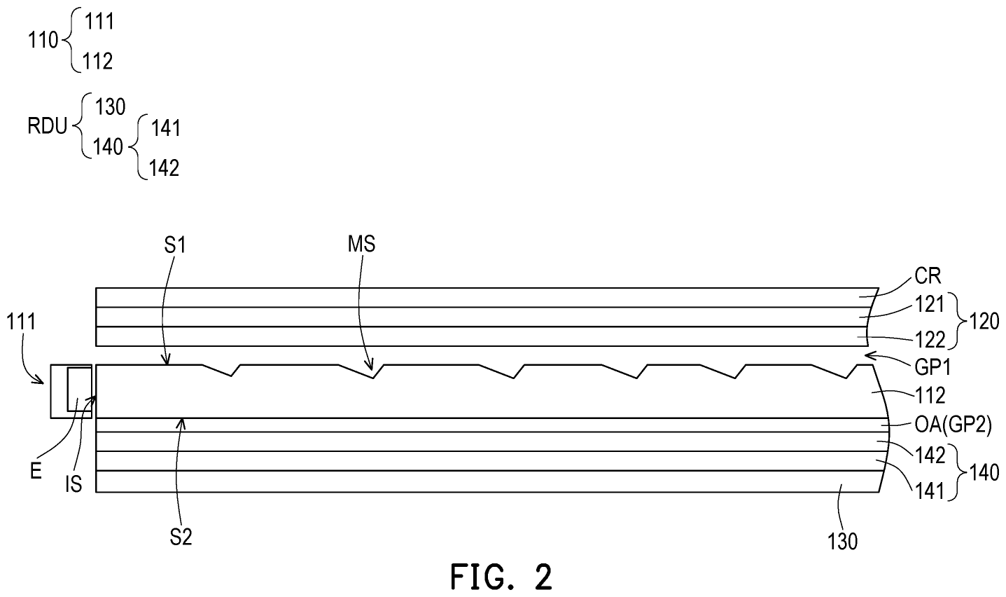

In this way, through a configuration of the first air gap layer GP1, most of the illumination light beam IL traveling in the light guide plate 112 may be smoothly transmitted to the reflective display unit RDU, and form to be an image light beam IM after reflected by the reflective display unit RDU, so that the display device 100 has good optical efficiency. Moreover, energy of stray light formed from the display device 100 directly transmitted from the light guide plate 112 of the front light module 110 of the display device 100 and energy of ambient light reflected on a surface of the light guide plate 112 may be absorbed by the first polarizing module 120, so that the display device 100 may maintain a good contrast. Further descriptions are given below with reference to FIG. 2 to FIG. 6.

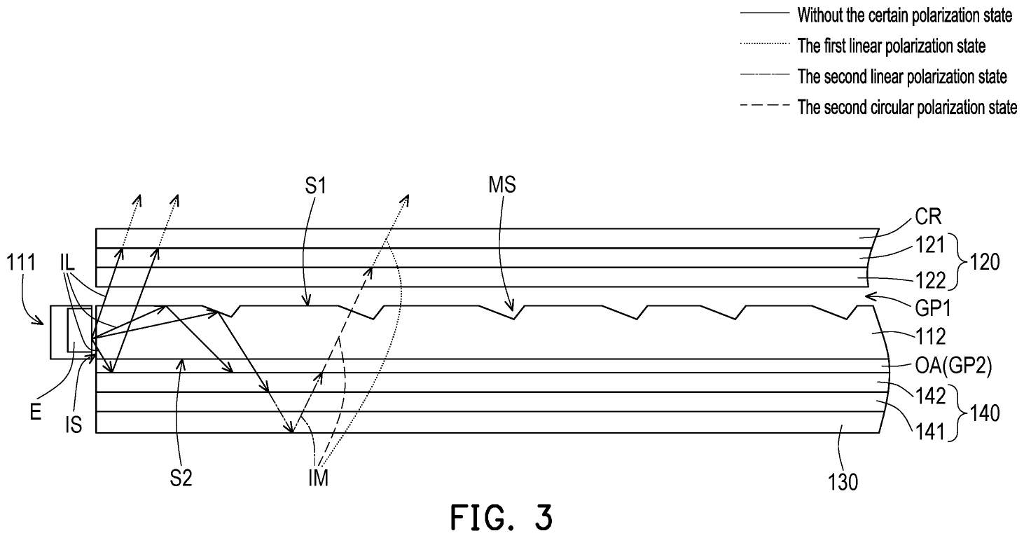

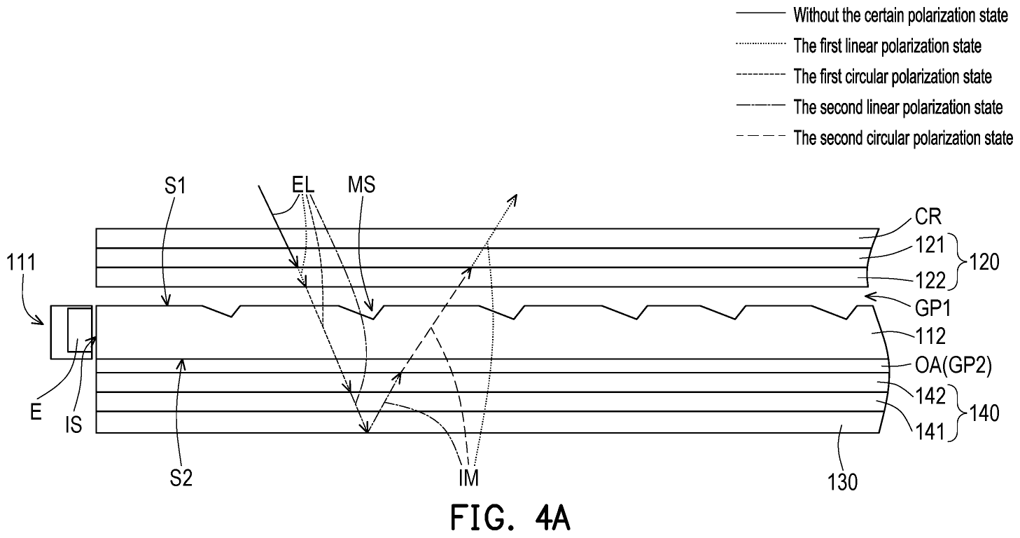

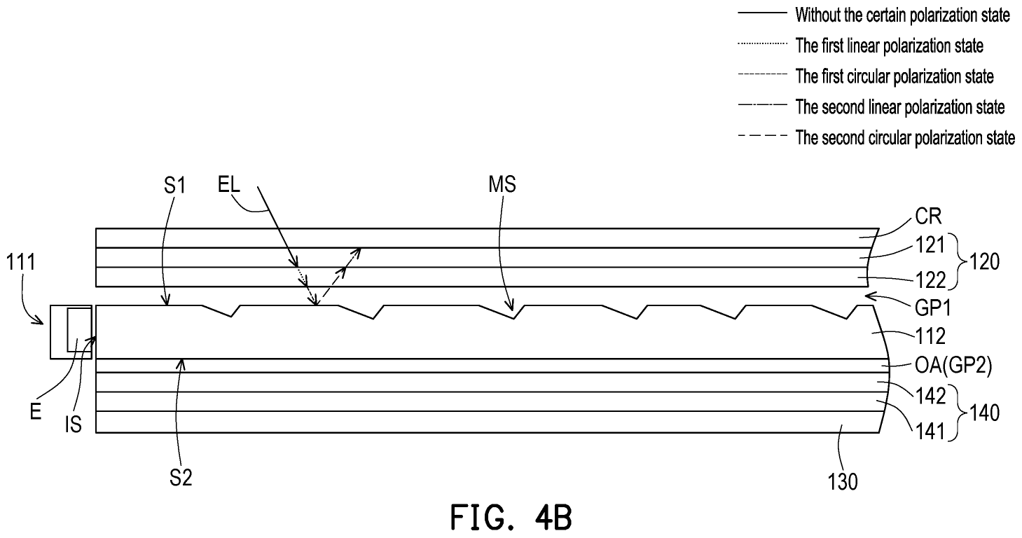

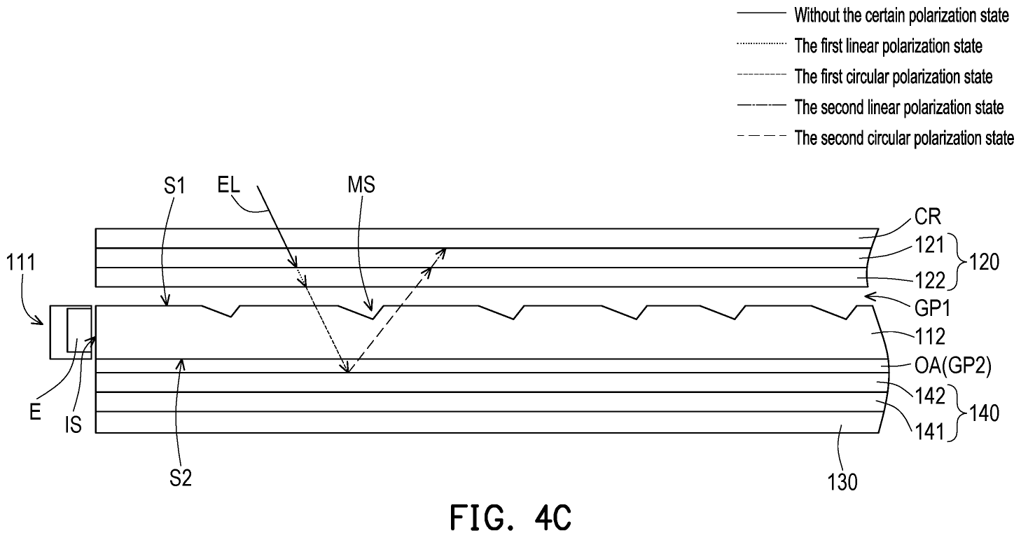

FIG. 2 is a schematic structural diagram of the display device in FIG. 1. FIG. 3 is a schematic diagram of a light path reflected on different interfaces by an illumination light beam of a light source in the display device in FIG. 2 FIG. 4A to FIG. 4C are schematic diagrams of light paths reflected on different interfaces by ambient light incident on the display device in FIG. 2. Specifically, as shown in FIG. 2, in this embodiment, the light guide plate 112 has a first surface S1 and a second surface S2 opposite to each other, and a light incident surface IS. The light source 111 is disposed next to the light incident surface IS of the light guide plate 112. For example, in this embodiment, the light source 111 may include a plurality of light emitting elements E. The light emitting elements E may adopt different types of light emitting elements such as a light emitting diode (LED), a mini light emitting diode (mini LED) or a micro light emitting diode (micro LED), which may be configured to provide the illumination light beam IL. In addition, the first surface S1 of the light guide plate 112 is located on a side of the light guide plate 112 close to the first polarizing module 120. That is, the first air gap layer GP1 is between the first surface S1 of the light guide plate 112 and the first polarizing module 120, and the first surface S1 of the light guide plate 112 is provided with a plurality of optical microstructures MS. The optical microstructures MS are, for example, recess microstructures recessed into the light guide plate 112 from the first surface S1.

As shown in FIG. 3, in this embodiment, through the configuration of the first air gap layer GP1, when the illumination light beam IL emitted by the light source 111 enters the light guide plate 112 through the light incident surface IS of the light guide plate 112, the illumination light beam IL may easily travel in the light guide plate 112 in a total internal reflection manner. Moreover, when the illumination light beam IL is transmitted to the optical microstructure MS, the illumination light beam IL is reflected by the optical microstructure MS and transmitted toward the reflective display unit RDU, and the illumination light beam IL is reflected by the reflective display unit RDU to form the image light beam IM. The image light beam IM is then transmitted out of the display device 100 through the light guide plate 112 and the first polarizing module 120. In addition, the display device 100 optionally includes a cover CR located on the first polarizer 121 of the first polarizing module 120 (that is, the first polarizer 121 is located between the cover CR and the first quarter wave plate 122), which may be configured to protect the first polarizer 121 from damage.

Moreover, as shown in FIG. 2 to FIG. 4C, in this embodiment, the reflective display unit RDU includes a reflective liquid crystal display panel 130 and a second polarizing module 140. Specifically, in this embodiment, the second polarizing module 140 is located between the reflective liquid crystal display panel 130 and the light guide plate 112, where the second polarizing module 140 includes a second polarizer 141 and a second quarter wave plate 142, and the second polarizer 141 is located between the reflective liquid crystal display panel 130 and the second quarter wave plate 142. Furthermore, in this embodiment, the display device 100 further includes an optical adhesive layer OA bonded between the light guide plate 112 and the second quarter wave plate 142. A projection area of the optical adhesive layer OA on the second surface S2 of the light guide plate 112 occupies, for example, more than 80% of an area of the second surface S2 of the light guide plate 112. In this way, since the difference in a refractive index between the optical adhesive layer OA and the light guide plate 112 is small, total internal reflection on the interface between the optical adhesive layer OA and the light guide plate 112 may be reduced.

Further, in this embodiment, an absorption axis of the second polarizer 141 is orthogonal to an absorption axis of the first polarizer 121, and an optical axis of the first quarter wave plate 122 is parallel to an optical axis of the second quarter wave plate 142. Besides, in this embodiment, an included angle between the optical axis of the first quarter wave plate 122 and the absorption axis of the first polarizer 121 is, for example, 45 degrees or 135 degrees. In this way, when passing through the first polarizer 121, the light without a certain polarization state may form light with a first linear polarization state. While passing through the second polarizer 141, the light without the certain polarization state may form light with a second linear polarization state, and a polarization direction of the first linear polarization state is perpendicular to a polarization direction of the second linear polarization state. On the other hand, when passing through the first quarter wave plate 122 or the second quarter wave plate 142, the light with the first linear polarization state forms into light with a first circular polarization state, and when passing through the first quarter wave plate 122 or the second quarter wave plate 142 again, the light with the first circular polarization state forms into the light with the second linear polarization state.

As shown in FIG. 3, in this embodiment, a part of the illumination light beam IL without a certain polarization state is not reflected by the reflective liquid crystal display panel 130 but penetrates the light guide plate 112 directly and is directly transmitted out of the display device 100 to form stray light. Alternatively, another part of the illumination light beam IL without the certain polarization state is reflected when transmitted to the second quarter wave plate 142 and is transmitted out of the display device 100 to form the stray light. After the stray light (the light beam is not transmitted to the reflective liquid crystal display panel 130) passes through the first polarizer 121 of the first polarizing module 120, more than half of the energy of the stray light is absorbed by the first polarizer 121 to form the light with the first linear polarization state. In this way, the brightness of the stray light may be effectively reduced, thereby improving a contrast of the display device 100.

In addition, as shown in FIG. 3, for the illumination light beam IL transmitted out of the light guide plate 112 and toward the reflective liquid crystal display panel 130, when passing through the second polarizer 141, the illumination light beam IL without the certain polarization state may form the light with the second linear polarization state, and after reflected by the reflective liquid crystal display panel 130, the illumination light beam IL with the second linear polarization state may form the image light beam IM. The image light beam IM is still the light with the second linear polarization state. After the image light beam IM with the second linear polarization state passes through the second quarter wave plate 142 and the first quarter wave plate 122 successively, a polarization state of the image light beam IM may convert from the original second linear polarization state to the second circular polarization and then to the first linear polarization state (that is, the polarization direction of the light beam is perpendicular to the absorption axis of the first polarizer 121). In this way, the image light beam IM may pass through the first polarizer 121 smoothly and be viewed by a user.

On the other hand, as shown in FIG. 4A, after passing through the first polarizer 121 of the first polarizing module 120, an ambient light EL without a certain polarization state may form the light with the first linear polarization state, and after the ambient light EL with the first linear polarization state passes through the first quarter wave plate 122 and the second quarter wave plate 142 successively, the polarization state of the ambient light EL may convert from the first linear polarization state to the first circular polarization state and then to the second linear polarization state, so that the ambient light EL may pass through the second polarizer 141 smoothly, and be transmitted to the reflective liquid crystal display panel 130. Moreover, the ambient light EL transmitted to the reflective liquid crystal display panel 130 and reflected by the reflective liquid crystal display panel 130 may form the image light beam IM. Similarly, after the image light beam IM with the second linear polarization state passes through the second polarizer 141, the second quarter wave plate 142, and the first quarter wave plate 122 successively, the polarization state of the image light beam IM may convert sequentially from the second linear polarization state to the second circular polarization stat and then to the first linear polarization state, so that the image light beam IM may pass through the first polarizer 121 smoothly.

Furthermore, as shown in FIG. 4B and FIG. 4C, after passing through the first polarizer 121 and the first quarter wave plate 122 of the first polarizing module 120, the ambient light EL without the certain polarization state may form the light with the first circular polarization state, and a part of the ambient light EL with the first circular polarization state may be reflected by the light guide plate 112 or the second quarter wave plate 142 to form the stray light. The stray light is reflected by the light guide plate 112 or the second quarter wave plate 142 and is converted to the second linear polarization state when passing through the first quarter wave plate 122 again. At this time, the ambient light EL with the second linear polarization state may be absorbed by the first polarizer 121. In this way, the brightness of the stray light formed by the ambient light EL may be effectively reduced, thereby improving the contrast of the display device 100.

Further, in order to prevent the illumination light beam IL or the ambient light EL with the certain polarization state from depolarizing during a transmission of the light guide plate 112, an in-plane phase retardation (R0) of the light guide plate 112 needs to be less than a certain value. For example, in this embodiment, the in-plane phase retardation of the light guide plate 112 is less than 50 nm. In this way, the illumination light beam IL or the ambient light EL may be ensured to have the certain polarization state during the transmission of the light guide plate 112, so that the display device 100 maintains a good function.

In addition, in this embodiment, the first quarter wave plate 122 of the first polarizing module 120 may be composed of a reverse wavelength dispersion material, or the first quarter wave plate 122 may be composed of a quarter wave plate and a half wave plate of a positive wavelength dispersion material. In this way, the first quarter wave plate 122 may generate a characteristic of the reverse wavelength dispersion material, and thus the difference of a phase retardation of the quarter wave plate 122 to light beams of different wavelengths may be further reduced. As a result, by controlling in-plane phase retardations of the first polarizer 121 and the first quarter wave plate 122 of the first polarizing module 120 and the included angle between the optical axis of the first quarter wave plate 122 and the absorption axis of the first polarizer 121, the first polarizing module 120 have an effect of a reverse wavelength dispersion characteristic, thereby reducing a formation of dispersion, so that the display device 100 has good optical efficiency.

On the other hand, similarly in this embodiment, the second quarter wave plate 142 of the second polarizing module 140 may also be composed of the reverse wavelength dispersion material, or the second quarter wave plate 142 may be composed of the quarter wave plate and the half wave plate of the positive wavelength dispersion material. In this way, the second quarter wave plate 142 may generate the characteristic of the reverse wavelength dispersion material. Moreover, by controlling the in-plane phase retardations of the second polarizer 141 and the second quarter wave plate 142 and the included angle between the optical axis of the second quarter wave plate 142 and the absorption axis of the second polarizer 141, the second polarizing module 140 have the effect of the reverse wavelength dispersion characteristic, thereby reducing the formation of dispersion, so that the display device 100 has good optical efficiency.

On the other hand, in order to prevent the light guide plate 112 and the first polarizing module 120 from being too close to each other and cause defects such as Newton's rings or wet out, the display device 100 may dispose a spacer in the first air gap layer GP1, and the spacer is disposed on a surface of the first quarter wave plate 122 facing the light guide plate 112, so that the display device 100 presents a good image.

In addition, in the foregoing embodiments, the optical adhesive layer OA is attached to the light guide plate 112 and the second quarter wave plate 142 and used as an example, but the disclosure is not limited thereto. In other embodiments, the optical adhesive layer OA may not be provided, but there is a second air gap layer GP2 between the light guide plate 112 and the second quarter wave plate 142. At this time, in order to prevent the light guide plate 112 and the second polarizing module 140 from being too close to each other and cause defects such as Newton's rings or wet out, the display device 100 may also dispose a spacer in the second air gap layer GP2, and the spacer is disposed on at least one of the surfaces facing each other of the second quarter wave plate 142 and the light guide plate 112. In this way, the display device 100 may also implement the aforementioned functions, thereby achieving the aforementioned effects and advantages, and is not described again here.

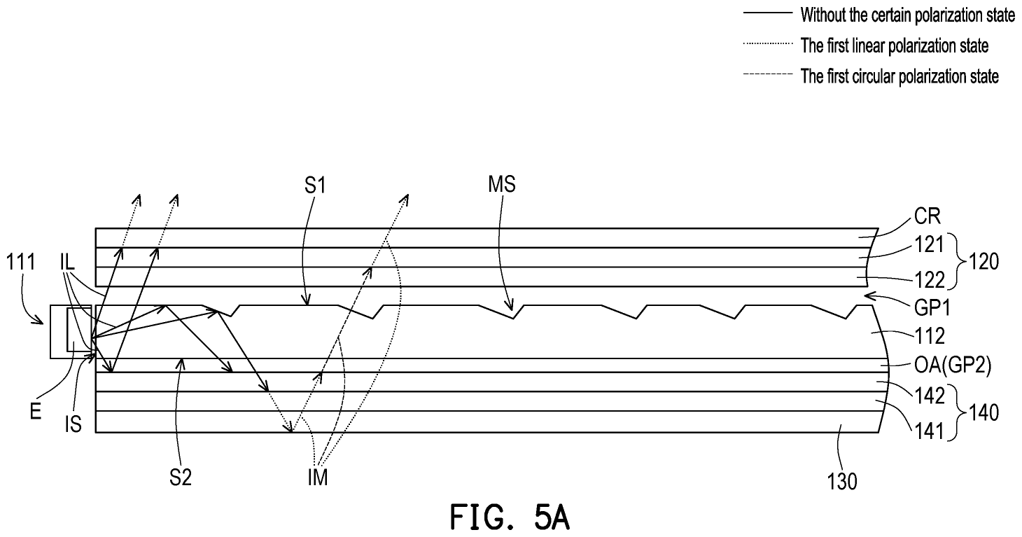

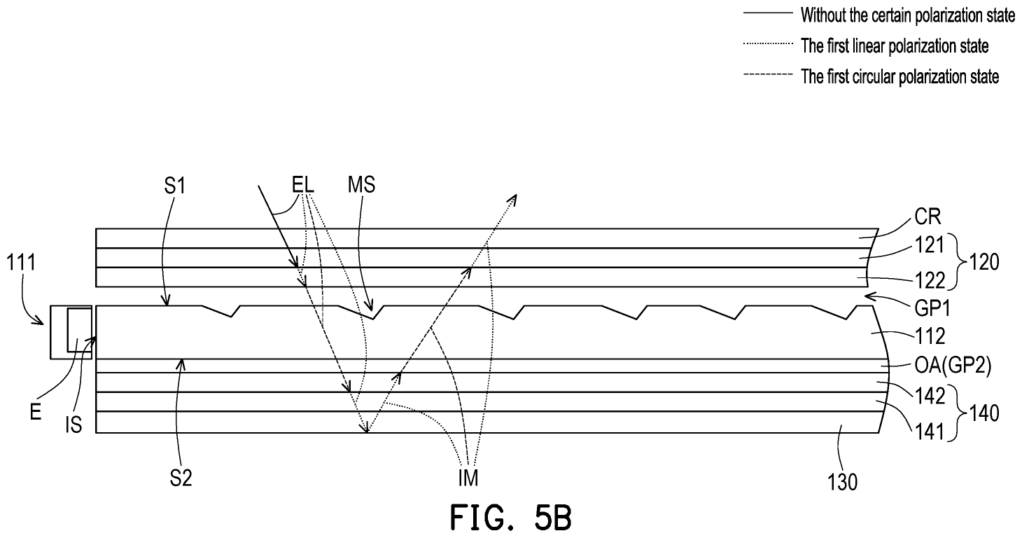

In addition, in the aforementioned embodiments, the absorption axis of the second polarizer 141 is orthogonal to the absorption axis of the first polarizer 121, and the optical axis of the first quarter wave plate 122 is parallel to the optical axis of the second quarter wave plate 142 as an example, but the disclosure is not limited thereto. In other embodiments, the absorption axis of the second polarizer 141 may also be parallel to the absorption axis of the first polarizer 121, and the optical axis of the first quarter wave plate 122 is orthogonal to the optical axis of the second quarter wave plate 142, so that the display device 100 may also implement the aforementioned functions, thereby achieving the aforementioned effects and advantages. Further descriptions are given below with reference to FIG. 5A and FIG. 5B.

FIG. 5A is a schematic diagram of another light path reflected on different interfaces by the illumination light beam of the light source in the display device in FIG. 2. FIG. 5B is a schematic diagram of another light path reflected on different interfaces by the ambient light incident on the display device in FIG. 2. Further, in this embodiment, since the absorption axis of the second polarizer 141 is parallel to the absorption axis of the first polarizer 121, and the optical axis of the first quarter wave plate 122 is orthogonal to the optical axis of the second quarter wave plate 142, the light without the certain polarization state may form the light with the first linear polarization state when passing through the first polarizer 121 or the second polarizer 141. On the other hand, when passing through the first quarter wave plate 122, the light with the first linear polarization state may form the light with the first circular polarization state, and the light with the first linear polarization state may form the light with the second circular polarization state different from the light with the first circular polarization state after passing through the second quarter wave plate 142. When passing through the first quarter wave plate 122 and then the second quarter wave plate 142, the light with the first linear polarization state may still form the light with the first linear polarization state.

As shown in FIG. 5A, in this embodiment, the part of the illumination light beam IL without the certain polarization state is not reflected by the reflective liquid crystal display panel 130 but penetrates the light guide plate 112 and is directly transmitted out of the display device 100 to form the stray light. Alternatively, the another part of the illumination light beam IL without the certain polarization state is reflected when transmitted to the second quarter wave plate 142 and is transmitted out of the display device 100 to form the stray light. After the stray light (the light beam is not transmitted to the reflective liquid crystal display panel 130) passes through the first polarizer 121 of the first polarizing module 120, more than half of the energy of the stray lights is absorbed by the first polarizer 121 to form the light with the first linear polarization state. In this way, the brightness of the stray light may be effectively reduced, thereby improving the contrast of the display device 100.

In addition, as shown in FIG. 5A, for the illumination light beam IL transmitted out of the light guide plate 112 and toward the reflective liquid crystal display panel 130, when passing through the second polarizer 141, the illumination light beam IL without the certain polarization state may form the light with the first linear polarization state, and after reflected by the reflective liquid crystal display panel 130, the illumination light beam IL with the first linear polarization state may form the image light beam IM. The image light beam IM is still the light with the first linear polarization state. After the image light beam IM with the first linear polarization state passes through the second quarter wave plate 142 and the first quarter wave plate 122 successively, the polarization state of the image light beam IM may convert from the original first linear polarization state to the first circular polarization and then to the first linear polarization state. In this way, the image light beam IM may pass through the first polarizer 121 smoothly and be viewed by the user.

On the other hand, as shown in FIG. 5B, after passing through the first polarizer 121 of the first polarizing module 120, the ambient light EL without the certain polarization state may form the light with the first linear polarization state, and after the ambient light EL with the first linear polarization state passes through the first quarter wave plate 122 and the second quarter wave plate 142 successively, the polarization state of the ambient light EL may convert from the first linear polarization state to the first circular polarization state and then to the first linear polarization state, so that the ambient light EL may pass through the second polarizer 141 smoothly, and then transmitted to the reflective liquid crystal display panel 130. Furthermore, the ambient light EL transmitted to the reflective liquid crystal display panel 130 may form the image light beam IM after reflected by the reflective liquid crystal display panel 130. Similarly, after the image light beam IM with the first linear polarization state passes through the second polarizer 141, the second quarter wave plate 142, and the first quarter wave plate 122 successively, the polarization state of the image light beam IM may sequentially convert from the first linear polarization state to the first circular polarization state and then to the first linear polarization state, so that the image light beam IM may pass through the first polarizer 121 smoothly and then penetrate the cover CR to form the image.

Moreover, in this embodiment, the polarization state of a part of the ambient light EL that is reflected when passing through the light guide plate 112 or the second quarter wave plate 142 is the same as that shown in FIG. 4B and FIG. 4C, and is not described here again.

In this way, the display device 100 may also implement the aforementioned functions, thereby achieving the aforementioned effects and advantages, and is not described again here.

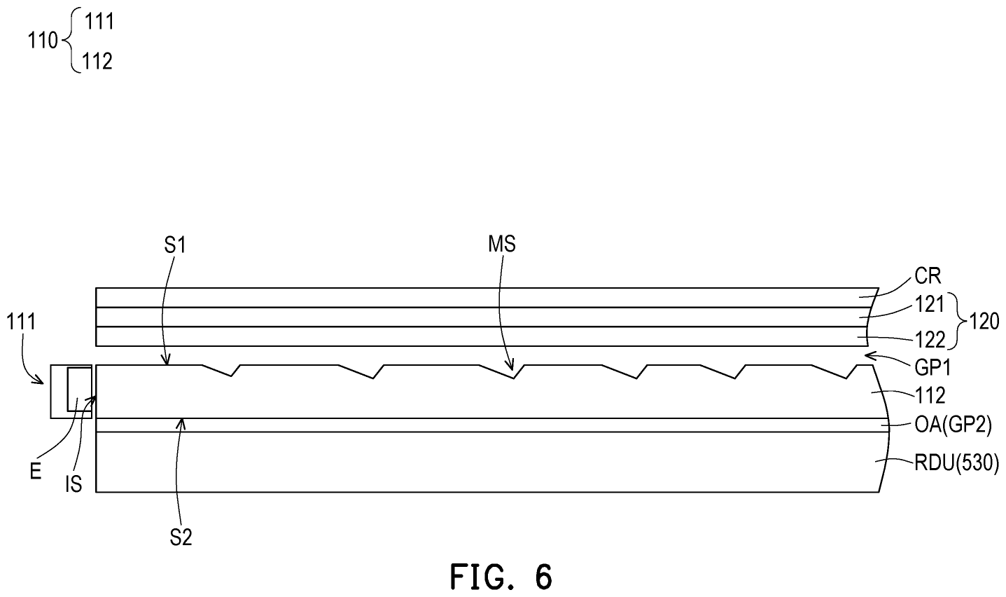

FIG. 6 is a schematic structural diagram of another display device in FIG. 1. In this embodiment, the reflective display unit RDU of the display device 100 is an electrophoretic display panel 530, and the second polarizing module 140 is not provided. The optical adhesive layer OA is bonded between the light guide plate 112 and the electrophoretic display panel 530. In this way, the brightness of the stray light generated by the illumination light beam may be effectively reduced, and the brightness of the stray light generated by the ambient light beam may also be effectively reduced.

To sum up, in the display device according to an embodiment of the disclosure, the energy of the stray light formed from the light guide plate of the front light module of the display device and the energy of the ambient light reflected on the surface of the light guide plate all may be absorbed by the first polarizing module, so that the display device may maintain a good contrast.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the present disclosure is intended to be dedicated to the public regardless of whether the element or component is explicitly recited in the following claims.

What is claimed is:

1. A display device, comprising a front light module, a first polarizing module, and a reflective display unit, wherein:
the front light module comprises a light guide plate and a light source, and the light source is disposed next to a light incident surface of the light guide plate; and
the first polarizing module comprises a first polarizer and a first quarter wave plate, wherein the first quarter wave plate is located between the light guide plate and the first polarizer, and there is a first air gap layer between the light guide plate and the first quarter wave plate;
wherein the light guide plate is located between the first polarizing module and the reflective display unit.

2. The display device according to claim 1, wherein an in-plane phase retardation of the light guide plate is less than 50 nm.

3. The display device according to claim 1, wherein an included angle between an optical axis of the first quarter wave plate and an absorption axis of the first polarizer is 45 degrees.

4. The display device according to claim 1, wherein the first quarter wave plate is a reverse wavelength dispersion material.

5. The display device according to claim 1, wherein the first quarter wave plate is composed of a quarter wave plate and a half wave plate of a positive wavelength dispersion material.

6. The display device according to claim 1, wherein the reflective display unit is an electrophoresis display panel, the display device further comprises an optical adhesive layer, and the optical adhesive layer is bonded between the light guide plate and the electrophoresis display panel.

7. The display device according to claim 1, wherein the reflective display unit comprises a reflective liquid crystal display panel and a second polarizing module,
wherein the second polarizing module is located between the reflective liquid crystal display panel and the light guide plate, the second polarizing module comprises a second polarizer and a second quarter wave plate, and the second polarizer is located between the reflective liquid crystal display panel and the second quarter wave plate.

8. The display device according to claim 7, wherein the display device further comprises an optical adhesive layer, the optical adhesive layer is bonded between the light guide plate and the second quarter wave plate.

9. The display device according to claim 7, wherein an absorption axis of the second polarizer is parallel to an absorption axis of the first polarizer, and an optical axis of the first quarter wave plate is orthogonal to an optical axis of the second quarter wave plate.

10. The display device according to claim 7, wherein an absorption axis of the second polarizer is orthogonal to an absorption axis of the first polarizer, and an optical axis of the first quarter wave plate is parallel to an optical axis of the second quarter wave plate.

11. The display device according to claim 7, wherein the second quarter wave plate is a reverse wavelength dispersion material.

12. The display device according to claim 7, wherein the second quarter wave plate is composed of a quarter wave plate and a half wave plate of a positive wavelength dispersion material.
